(19) United States
(12) Patent Application Publication
(10) Pub. No.: US 2008/0043231 A1
(43) Pub. Date: Feb. 21, 2008

(54) Analysis Device

(76) Inventor: Takemi Hasegawa, Kanagawa (JP)

Correspondence Address: GLOBAL IP COUNSELORS, LLP, 1233 20TH STREET, NW, SUITE 700, WASHINGTON, DC, 20036-2680, US

(21) Appl. No.: 11/663,756

(22) PCT Filed: Sep. 26, 2006
(86) PCT No.: PCT/JP2006/319025

§ 371 Date: Mar. 26, 2007

(30) Foreign Application Priority Data
Sep. 29, 2005 (JP) 2005-284230

(51) Int. Cl. G01J 3/30

(52) U.S. Cl. 356/317

(57) ABSTRACT

An analysis device is capable of identifying each constituent element of a measurement object. The analysis device includes a broadband light generation source configured and arranged to generate broadband light having a bandwidth of 300 nm or greater in a wavelength band of 750 nm to 2,500 nm in substantially a single spatial mode, a radiating optical system configured and arranged to radiate the broadband light to an irradiation region of a measurement object, a capturing optical system configured and arranged to capture object light emitted from the irradiation region, a time-resolved spectroscope configured and arranged to receive the object light and calculating a temporal intensity variation for each wavelength component of the object light, and an analysis unit configured and arranged to analyze a component of the measurement object on the basis of the temporal intensity variation.

### TECHNICAL FIELD

The present invention relates to a device for analyzing components of a measurement object.

### BACKGROUND ART

U.S. Pat. No. 6,741,875 discloses a technique for analyzing components of a measurement object. In this analysis technique, light having a plurality of wavelengths in the near-infrared wavelength band is radiated simultaneously to a measurement object, and the light absorption coefficients of the measurement object at each wavelength are simultaneously measured, whereby the concentrations of specific substances in the measurement object are found. This type of spectral analysis using light that is in or near the near-infrared wavelength band (750 nm to 2,500 nm, for example) is capable of measuring an absorption line created by the harmonic vibration or combination vibration of fundamental vibration of molecules and other constituent elements of the measurement object. This type of spectral analysis is therefore used in component analysis of biological fluids and the like.

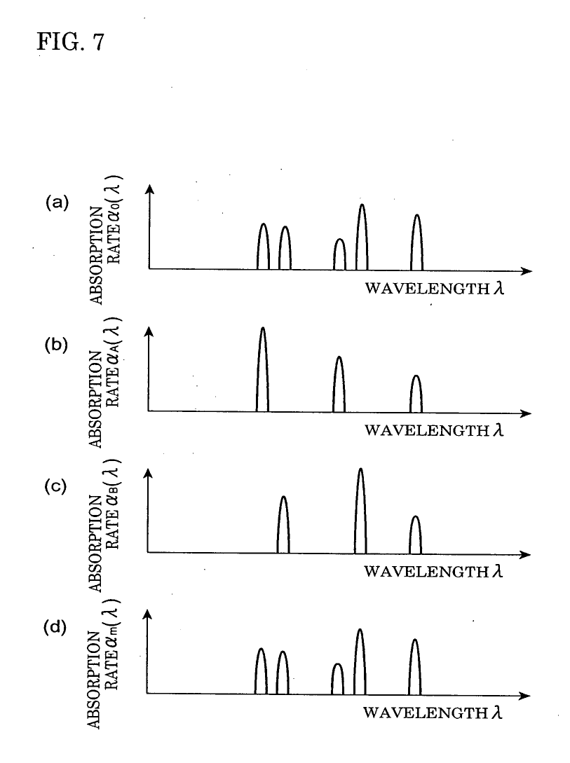

FIG. 7 is a schematic diagram illustrating the conventional analysis technique. In the conventional analysis technique, the near-infrared absorption spectrum a_{O}(λ) (portion (a) of FIG. 7) of the measurement object is first measured. The mass of each constituent element A, B in the measurement object is then estimated from a near-infrared absorption spectrum a_{A}(λ) (portion (b) of FIG. 7) per unit concentration of constituent element A and a near-infrared absorption spectrum a_{B}(λ) (portion (c) of FIG. 7) per unit concentration of constituent element B that are prepared in advance. In the estimation, the estimated absorption spectrum aₘ (portion (d) of FIG. 7) is expressed by the equation below, and the estimated value c_{A} and the estimated value c_{B} are determined so that spectrum aₘ(λ) most closely matches spectrum a_{O}(λ).
aₘ(λ)=c_{A}a_{A}(λ)+c_{B}a_{B}(λ)
(In the equation, c_{A} is an estimated concentration of constituent element A, and c_{B} is an estimated concentration of constituent element B.)
Patent Document 1: U.S. Pat. No. 6,741,875

### DISCLOSURE OF INVENTION

### Problem to be Solved by the Invention

An object of the present invention is to provide an analysis device that is capable of easily identifying each constituent element of a measurement object even when the measurement object includes a plurality of constituent elements whose spectra overlap to a significant degree.

### Means for Solving the Problem

To achieving the abovementioned objects, the present invention provides an analysis device comprising a broadband light source configured and arranged to generate broadband light having a bandwidth of 300 nm or more in the wavelength band of 750 nm to 2,500 nm in substantially a single mode, a radiating optical system configured and arranged to radiate the broadband light to an irradiation region of a measurement object, a capturing optical system configured and arranged to capture, as object light, the broadband light emitted from the irradiation region, a time-resolved spectroscope configured and arranged to receive the object light and calculating a temporal intensity variation for each wavelength component of the object light, and an analysis unit configured and arranged to analyze a component of the measurement object on the basis of the temporal intensity variation.

### ADVANTAGE OF THE INVENTION

The analysis device of the present invention is capable of easily identifying each constituent element of a measurement object even when the measurement object includes a plurality of constituent elements whose spectra overlap to a significant degree.

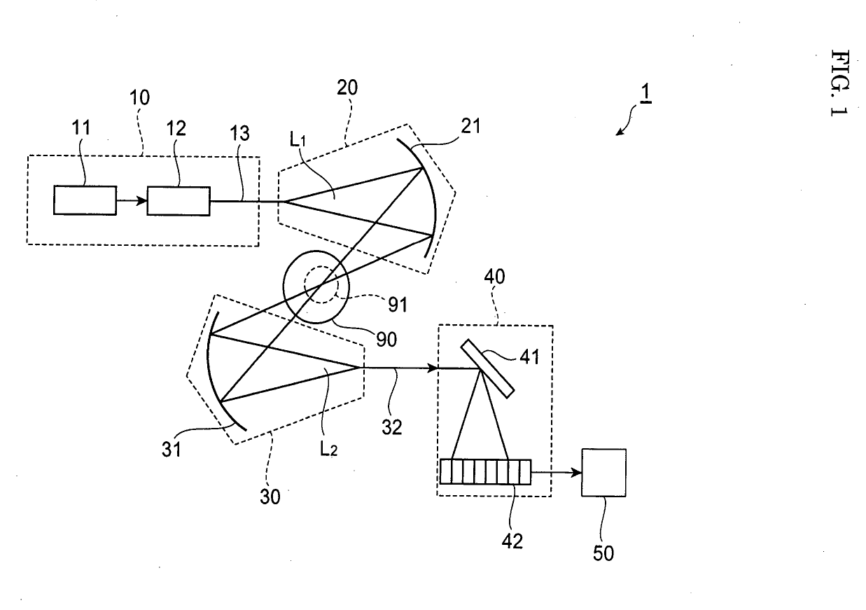

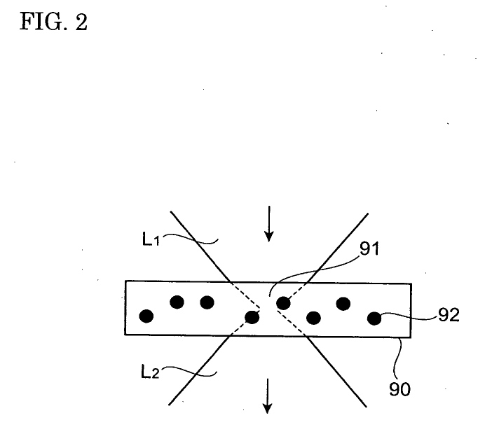

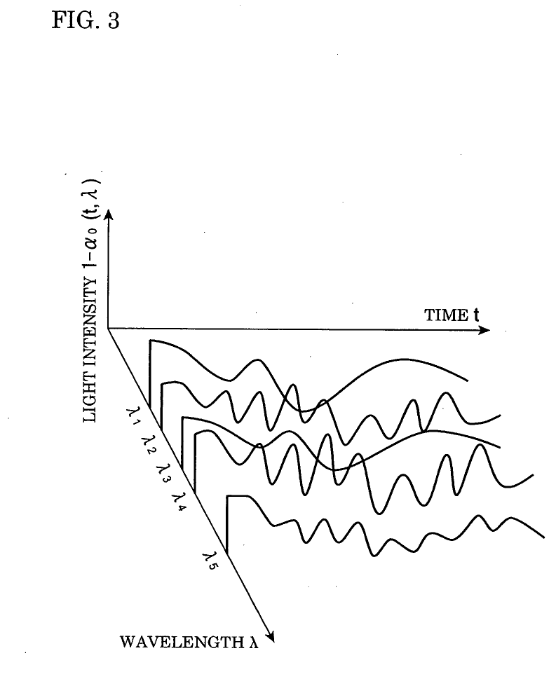

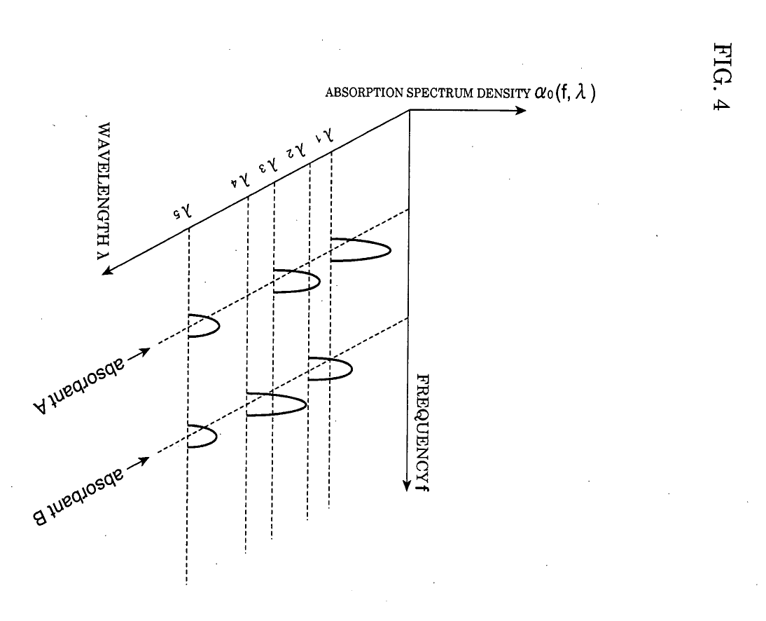

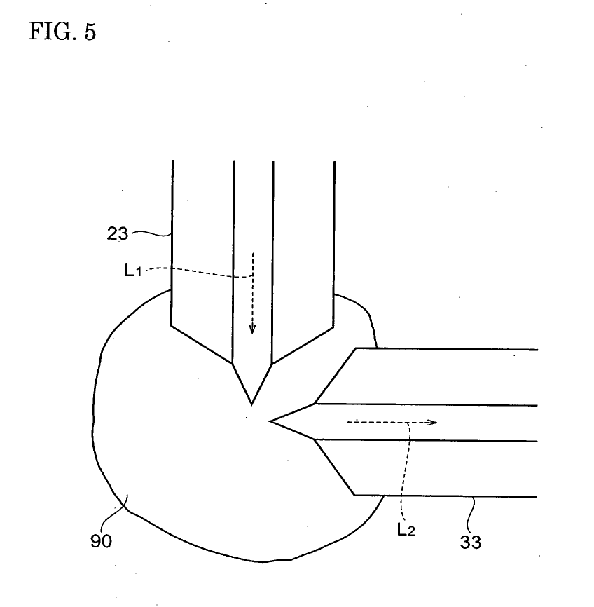

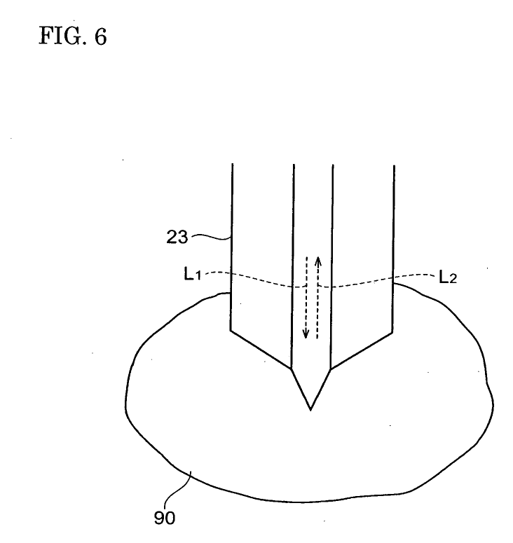

### BRIEF DESCRIPTION OF DRAWINGS

[FIG. 1] A schematic diagram of an analysis device according to the first embodiment of the present invention.

[FIG. 2] A schematic diagram showing broadband light radiation to a measurement object and object light emission from the object.

[FIG. 3] A graph showing an example of temporal intensity variation for wavelength components of object light as calculated by the time-resolved spectroscope of the analysis device according to the first embodiment.

[FIG. 4] A graph showing an example of absorption rate frequency spectra for the wavelength components of object light as calculated by the time-resolved spectroscope of the analysis device according to the first embodiment.

[FIG. 5] A schematic diagram showing a radiating optical system and capturing optical system of an analysis device according to the second embodiment of the present invention in the measurement region.

[FIG. 6] A schematic diagram showing a radiating optical system and capturing optical system of an analysis device according to the third embodiment of the present invention in the measurement region.

[FIG. 7] A schematic diagram illustrating a conventional analysis technique.

### DESCRIPTION OF THE REFERENCE NUMERALS

1 analysis device,
10 broadband light source,
11 pump light source,
12 spectrum expander,
13 light output unit,
20 radiating optical system,
21 curved mirror,
23 optical fiber probe,
30 capturing optical system,
31 curved mirror,
33 optical fiber probe,
40 time-resolved spectroscope,
41 dispersion unit,
42 light detection unit,
50 analysis unit,
90 measurement object,
91 irradiation region

### BEST MODE FOR CARRYING OUT THE INVENTION

Embodiments of the present invention will be described hereinafter with reference to the drawings. The drawings are only for description and in no way limit the scope of the invention. The same reference numerals indicate the similar components in the drawings to prevent redundancy in the description. The dimensional ratios in the drawings are also not necessarily correct.

FIG. 1 is a schematic diagram showing an analysis device according to the first embodiment of the present invention. The analysis device 1 is provided with a broadband light source 10, a radiating optical system 20, a capturing optical system 30, a time-resolved spectroscope 40, and an analysis unit 50 and analyzes a measurement object 90.

The broadband light source 10 includes a pump light source 11, a spectrum expander 12, and a light output unit 13 and generates broadband light L₁ having a bandwidth of 300 nm or more in the wavelength band of 750 nm to 2,500 nm in substantially a single mode. The pump light source 11 generates pulse laser light having a high peak power. The spectrum expander 12 converts the pulse laser light which is generated by the pump light source 11 to the broadband light L₁ by broadening the spectrum of the pulse laser light with a nonlinear optical effect. The light output unit 13 outputs the broadband light L₁ in substantially a single mode.

The spectrum expander 12 is a nonlinear optical medium (preferably a highly nonlinear optical fiber, for example) having a high degree of nonlinearity and a small absolute value of wavelength dispersion at the central wavelength of the pulse laser light that is output from the pump light source 11. The spectrum of the pulse light incident on the spectrum expander 12 is expanded by a nonlinear optical effect, and broadband light (supercontinuum light) is obtained. A single-mode optical fiber is suitable as the spectrum expander 12. A single-mode optical fiber is also suitable as the light output unit 13.

The wavelength range of the broadband light output from the broadband light source 10 preferably includes an absorption wavelength that characterizes the measurement object 90. In order to satisfy this condition, broadband light that expands over a bandwidth of at least 300 nm or more is preferably used. Absorption wavelengths that correspond to the energy of harmonic vibration or combination vibration, which depend on the surrounding environment of molecular bonds through an anharmonic term, of the fundamental vibration of a molecules are in the near-infrared wavelength band (750 nm to 2,500 nm). The near-infrared wavelength band is therefore suited for analysis of protein molecules and other complex molecules.

Radiating light in various wavelengths simultaneously to the measurement object 90 by using the supercontinuum light generated by the spectrum expander 12, which is a highly nonlinear optical fiber, makes it possible to measure the temporal variation of an absorption spectrum at a high temporal resolution, and is therefore preferred. This method is also preferred because the supercontinuum light generated in the optical fiber has high directivity, and it is therefore possible to focus measurement light in a minute region of the measurement object 90 and to observe the fluctuations of the measurement object 90 in a liquid phase due to Brownian motion, as described hereinafter. The high directivity also makes it possible to obtain high wavelength resolution when the object light emitted from the measurement object 90 is measured after being spatially separated for each wavelength by a dispersion unit 41.

The light output unit 13, which is a single-mode optical fiber, inputs the broadband light generated by the spectrum expander 12 into one end thereof, guide it, and emits it into a space from the other end thereof. The light output unit 13, which is a single-mode optical fiber, effectively operates in a single mode in the wavelength band of the broadband light. Effective single-mode operation herein means that it is possible to ignore mode conversion of light energy incident in a fundamental mode to a higher-order mode. The single-mode optical fiber used as the light output unit 13 may be a portion of the highly nonlinear optical fiber used as the spectrum expander 12. It is preferable that the highly nonlinear optical fiber as the spectrum expander 12 operates substantially single-mode in the wavelength band of the broadband light is preferred because loss due to coupling of the energy of the broadband light and a higher-order mode is prevented.

The radiating optical system 20 includes a curved mirror 21, and radiates the broadband light L₁ generated by the broadband light source 10 to an irradiation region 91 of the measurement object 90. The curved mirror 21 focuses and radiates the broadband light L₁ output from the light output unit 13 in the broadband light source 10 to the irradiation region 91. A curved mirror or other optical element having little aberration is preferably used in order to focus light having a wide wavelength band into the same irradiation region. A lens may also be used depending on the wavelength bandwidth or the size of the irradiation region. The radiated light that is focused onto the irradiation region 91 of the measurement object 90 is absorbed differently for each wavelength in the irradiation region 91, and the light that is reflected or scattered is emitted from the irradiation region 91 as object light.

The capturing optical system 30 includes a curved mirror 31 and an optical fiber 32, and captures object light L₂ emitted from the irradiation region 91 in conjunction with the radiation of the broadband light L₁. The curved mirror 31 captures the object light L₂ emitted from the irradiation region 91. The optical fiber 32 guides the captured object light incident on one end thereof, and outputs the object light from the other end to a time-resolved spectroscope 40. The use of a curved mirror or other optical element having minimal aberration is preferred also in the capturing optical system 30. A lens may also be used depending on the wavelength bandwidth or the size of the irradiation region. The optical fiber 31 is preferably a single-mode optical fiber in order to obtain high spectral accuracy or to remove stray light. A multi-mode fiber may also be used to increase the power of the captured object light.

The time-resolved spectroscope 40 includes a dispersion unit 41 and a light detection unit 42, and receives the object light L₂ captured by the capturing optical system 30 and calculates a temporal intensity variation for each wavelength component of the object light. The dispersion unit 41 decomposes each wavelength component of the object light captured by the capturing optical system 30 to a different spatial position. A diffraction grating, for example, is suitable as the dispersion unit 41.

The light detection unit 42 detects the temporal intensity variation of each wavelength component that was decomposed by the dispersion unit 41 synchronously with the timing at which the pulse laser light is generated in the pump light source 11. An array detector in which numerous photoreceptor elements are arranged in an array is suitable as the light detection unit 42. It is preferable that a trigger signal indicating the timing of the pulse light output from the pump light source 11 be fed to the array detector and light that is synchronized with the trigger signal be detected by the light detection unit 42. Noise can thereby be suppressed, and higher speed fluctuations can be measured. A streak camera may also be used instead of the diffraction grating and array detector to perform time-resolved spectral measurement.

The analysis unit 50 analyzes the components of the measurement object on the basis of the temporal intensity variation which is calculated by the time-resolved spectroscope 40 for each wavelength component of the object light. An example of this analysis method is described below.

FIG. 2 is a schematic diagram showing broadband light radiation to the measurement object and object light emission from the object. The measurement object 90 is generally in a liquid phase and is accommodated in a transparent sample cell. The broadband light L₁ focused by the curved mirror 21 is radiated to a minute irradiation region 91 of the measurement object 90. A portion of the radiated broadband light is absorbed by molecules or other constituent elements 92 (indicated by black circles in the drawing) in the irradiation region 91, and object light L₂ is generated by reflection or scattering. The object light L₂ is captured by the curved mirror 31, focused at one end of the optical fiber 32, and transmitted to the time-resolved spectroscope 40.

When the concentration of the constituent elements 92 in the measurement object 90 is 1 nmol/liter, for example, the average interval between each of the constituent elements 92 is 1.2 μm. If the diameter of the irradiation region 91 is set to a multiple (e.g., 2 μm) or less of the average interval between the constituent elements 92, it is possible to observe fluctuations of the absorption spectrum due to the constituent elements 92 entering and exiting the measurement region 92 one by one by Brownian motion.

In the conventional analysis technique, it was difficult to decompose the light absorption spectra obtained as measurement results into the light absorption spectra of the constituent elements, and the constituent elements were difficult to identify when the measurement object included a plurality of constituent elements for which single spectra overlap with each other to a significant degree (e.g., when analyzing proteins and other large molecules). However, the analysis device of the present invention is capable of easily identifying each constituent element even when the measurement object includes a plurality of constituent elements whose spectra overlap to a significant degree.

FIG. 3 is a graph showing an example of temporal intensity variation for wavelength components of object light as calculated by the time-resolved spectroscope 40 of the analysis device 1 according to the first embodiment. FIG. 3 shows the temporal intensity variation 1&#8722;a_{O}(t, λ) of the object light for each wavelength λ₁ through λ₅ included in the wavelength band of the broadband light output from the broadband light source 10, where t indicates time, and λ indicates wavelength. This type of temporal intensity variation (temporal fluctuations in intensity) of each wavelength component of the object light is generated by the Brownian motion of the constituent elements 92 included in the measurement object 90, which is in the liquid phase. The variation may also be generated by imparting flow or vibration to the measurement object 90.

In order to easily observe the temporal intensity variation of each wavelength component of the object light, it is preferable that the broadband light output from the broadband light source 10 is focused by the radiating optical system 20, and the irradiation region 91 in the measurement object 90 to which the broadband light is radiated is made extremely small. The absorption spectrum obtained from the object light emitted from the irradiation region 91 in conjunction with the radiation of broadband light has an absorption line at a wavelength that corresponds to the absorption line of the constituent elements 92 in the measurement object 90. Each absorption line exhibits temporal fluctuation that has characteristics specific to certain constituent elements 92. The absorption line can be traced back to the constituent elements 92 based on the fluctuation characteristics.

The constituent elements 92 may be sorted with a fluctuation frequency component, as the fluctuation characteristics, which is derived from the time waveform of the fluctuations through a frequency spectrum a_{O}(f, λ) of the fluctuations, as shown in FIG. 4, Fourier transformed from the time waveform. Herein, f indicates the frequency of fluctuations. Although not shown in the drawing, a time derivative waveform may be used instead of a Fourier transformed frequency spectrum. In this case, peaks or dips occur at a time at which a constituent element 92 enters or exits the irradiation region 91 due to Brownian motion and the like, and components that have peaks and dips at the same times can therefore be traced back to the same constituent elements. The movement of the constituent element 92 may utilize Brownian motion, convection, or another spontaneous phenomenon. It is also effective to impart flow or vibration deliberately.

FIG. 5 is a schematic diagram showing the radiating optical system and capturing optical system of the analysis device according to the second embodiment of the present invention. In the optical systems shown in FIG. 5, an optical fiber probe 23 is used as the radiating optical system, and an optical fiber probe 33 is used as the capturing optical system. The distal ends of the glass fibers of the optical fiber probes 23, 33 are tapered to a point, and the distal ends of the optical fiber probes 23, 33 are inserted into the measurement object 90. The optical fiber probe 23 guides the broadband light L₁ generated by the broadband light source 10, and the broadband light L₁ is output as evanescent light from the distal end. The object light L₂ emitted from the irradiation region enters the distal end of the optical fiber probe 33, and the object light L₂ is guided to the time-resolved spectroscope 40.

FIG. 6 is a schematic diagram showing the radiating optical system and capturing optical system of the analysis device according to the third embodiment of the present invention. In the optical systems shown in FIG. 6, the same optical fiber probe 23 is used as the radiating optical system and the capturing optical system. The distal end of the optical fiber probe 23 is inserted into the measurement object 90. The optical fiber probe 23 guides the broadband light L₁ generated by the broadband light source 10, and the broadband light L₁ is output as evanescent light from the distal end. The object light L₂ emitted from the irradiation region enters the distal end of the optical fiber probe 23, and the object light L₂ is guided to the time-resolved spectroscope 40. A beam splitter for separating the broadband light L₁ and the object light L₂ is provided to the other end of the glass fiber that constitutes the optical fiber probe 23.

As shown in FIG. 5, when an optical fiber probe is used as the radiating optical system, the region in which the broadband light L₁ is radiated as evanescent light from the distal end of the radiating optical system can be made extremely small. When an optical fiber probe is used as the capturing optical system as shown in FIG. 6, the object light L₂ emitted from the minute region can enter the distal end of the optical fiber probe, which is the capturing optical system.

The present application is based on Japanese Patent Application No. 2005-284230 filed on Sep. 29, 2005, the entire content of which is incorporated herein by reference.

### INDUSTRIAL APPLICABILITY

The analysis device of the present invention may be used for component analysis of biological fluids, for example.

What is claimed is:

1. An analysis device comprising:
a broadband light generation source configured and arranged to generate broadband light having a bandwidth of 300 nm or greater in a wavelength band of 750 nm to 2,500 nm in substantially a single spatial mode;
a radiating optical system configured and arranged to radiate said broadband light to an irradiation region of a measurement object;
a capturing optical system configured and arranged to capture as object light emitted from said irradiation region;
a time-resolved spectroscope configured and arranged to receive the object light and calculating a temporal intensity variation for each wavelength component of the object light; and
an analysis unit configured and arranged to analyze a component of the measurement object on the basis of the temporal intensity variation.

2. The analysis device according to claim 1, wherein said broadband light generation source comprises:
a seed light source configured and arranged to generate pulse laser light;
a spectrum expander configured and arranged to convert the pulse laser light to the broadband light by broadening a spectrum of the pulse laser light by a nonlinear optical effect; and
a light output unit configured and arranged to output the broadband light in substantially a single spatial mode.

3. The analysis device according to claim 2, wherein said spectrum expander is a single-mode optical fiber.

4. The analysis device according to claim 1, wherein said time-resolved spectroscope comprises:
a dispersion unit configured and arranged to decompose each of the wavelength components in a different spatial position; and
a light detection unit configured and arranged to detect a temporal intensity variation of the wavelength components in synchrony with a timing at which the pulse laser light is generated.

5. The analysis device according to claim 1, wherein said radiating optical system comprises a curved mirror configured and arranged to focus and radiate the broadband light to the irradiation region.

6. The analysis device according to claim 1, wherein said capturing optical system comprises a curved mirror configured and arranged capture and output said object light to said time-resolved spectroscope.

7. The analysis device according to claim 1, wherein said radiating optical system comprises an optical fiber probe configured and arranged guide and output the broadband light as evanescent light from a distal end.

8. The analysis device according to claim 1, wherein said capturing optical system comprises an optical fiber probe in which the object light is inputted to a distal end and guided to said time-resolved spectroscope.
